(19) United States
(12) Patent Application Publication
(10) Pub. No.: US 2026/0132307 A1
(43) Pub. Date: May 14, 2026

(54) A MATTING AGENT AND POLYURETHANE COATING COMPOSITIONS THEREWITH

(71) Applicant: Grace GmbH, Worms (DE)

(72) Inventors: Matthias Märcz, Heidelberg (DE); Horst Herrig, Bolanden (DE)

(73) Assignee: Grace GmbH, Worms (DE)

(21) Appl. No.: 18/701,196

(22) PCT Filed: Oct. 13, 2022
(86) PCT No.: PCT/US2022/046608

§ 371 Date: Apr. 12, 2024

Related U.S. Application Data
(60) Provisional application No. 63/255,349, filed on Oct. 13, 2021.

(51) Int. Cl. C09D 175/06; C08G 18/22; C08G 18/24; C08G 18/42; C08G 18/80; C08K 3/36; C08K 7/26

(52) U.S. Cl. CPC C09D 175/06; C08G 18/222; C08G 18/227; C08G 18/242; C08G 18/42; C08G 18/8074; C08G 18/8077; C08K 3/36; C08K 7/26; C08K 2201/005; C08K 2201/006

(57) ABSTRACT

The present technology provides a matting agent for a polyurethane coating composition, which comprises porous silica particles having a ratio of BET surface area to pore volume (SA:PV) of 160 m²/mL or less. The technology also provides a polyurethane coating composition and cured coatings thereof. The compositions include the matting agent, a polyol, a cross-linking agent, and a catalyst.

### CROSS-REFERENCE TO RELATED APPLICATIONS

This application claims the benefit of priority to U.S. Provisional Patent Application No. 63/255,349, filed Oct. 13, 2021, and which is incorporated herein by reference in its entirety.

### FIELD

The present invention relates generally to the field of matting agents and polyurethane coatings comprising matting agents.

### BACKGROUND

A coating material is a product that is usually a mixture of volatile and non-volatile constituents in the form of liquid, paste, or powder that forms a layer or coating from the non-volatile constituents when applied to a substrate and cured under the defined conditions to remove the volatile constituents. The coating material may include at least one non-volatile film forming substance, usually referred to as binder or resin, and other conventional components such as solvents, diluents, extenders, pigments, dyes, and/or additives.

A coating material may be provided as a single-pack system (1 component) or a multi-pack system (2 or more separate components). In a multi-pack system, the two or more separate components must be mixed according to the coating product specifications before application. Multi-pack coating systems are predominantly two component systems in which the components include a binder and hardener (also called a curing agent).

After application, the coating material forms a solid layer or coating by changing from liquid or paste state to solid state under the defined environmental conditions with the exception of powder coatings which undergo a change from solid to liquid and back to solid. This process results in a layer or coating that possesses protective, decorative, and/or other functional or desired properties.

Typically, the coating process includes at least a drying step and may include a curing step. In the drying step, the volatile constituents of the coating material are evaporated resulting in the solidification of the layer. In the curing step, a hardener increases the molecular size of the resin by chemical reaction. Both steps may happen in parallel. Depending on the coating technology, the hardener is added to the resin component prior to application (2 or multi-pack products), or is mixed into the resin component in its latent state (single-pack) or is part of the environmental conditions during the curing step (single pack). The hardener may also be a latent hardener that needs to be activated during the curing step to ensure that resin and hardener chemically react to form a layer of the desired properties. Latent hardeners do not react with the resin under storage conditions, thus allowing for good shelf life, but they can be activated by a stimulus during the processing step. The activation may be done at elevated temperatures.

Single-pack coating systems may be preferred to multi-pack systems, because single-packs allow avoidance of mixing errors, ease of handling, and process implementation (no need for mixing equipment etc.). However, traditional single-pack coatings products often have limitations relating to product durability, e.g. lower mechanical properties and/or lower chemical resistance as compared to multi-pack systems. This is because the formation of the coating layer is dominated by physical drying, i.e. evaporation of the volatile part of the coating material, due to absence of a hardener. The reaction rate determines crucial coating material properties such as the curing time (i.e., time between application of the coating material and its readiness for the foreseen application) and pot-life for multi-pack systems. To combine the advantages of a single-pack (ease of processing) with a multi-pack (durability) coating products, the usage of latent hardeners inside the coating material (e.g., blocked isocyanate in a polyurethane coating composition) was developed.

Generally, polyurethane coating compositions include a binder comprising hydroxyl functionalities (e.g., a polyol) and a hardener comprising isocyanate functionalities. Both functionalities must be accessible during the curing step to ensure a chemical reaction. The chemical reaction between the hardener and binder leads to a thermoset type polymer joined mostly by carbamate linkages (i.e., urethane linkages). In presence of water, the polymer may partially be joined by carbamide linkages (i.e., urea linkages). Due to the relatively low reaction rate between polyols and isocyanates at lower temperatures (e.g., room temperature) polyisocyanates are usually catalyzed to adapt the reaction rate. Most common catalysts are metal complexes (including, but not limited to tin-based dibutyltin dilaurate (DBTL)) and/or tertiary amines. Depending on the chemical nature of the catalyst, it may activate the isocyanate functionality, the hydroxyl functionality, or both to increase the chemical reaction rate.

Blocked isocyanates in combination with polyol-type resins are widely used in polyurethane coatings compositions and works as a latent hardener. The isocyanate may be unblocked by elevated temperature after which the hardener becomes active and reacts with the polyol resins to form the coating layer. The deblocking temperature is determined by a variety of parameters, but mostly by the chemistry of the blocking agent, the presence of catalysts, and the presence of polyols.

A single-pack polyurethane type product using blocked isocyanates may therefore achieve similar durability as traditional multi-pack polyurethane coating products while keeping the ease of handling. However, in high bake coating systems (e.g., coil coatings, can coatings, automotive coatings, and electrical wire coatings), a high degree of automatization, as well as a high degree of optimization towards production speed, requires a very fast curing coating system. In continuous processes, like coil coating lines, high levels of productivity may be lost if the line rate has to be reduced because of a slow cure response.

Catalysts also play an essential role in such polyurethane coating systems. Typically, the catalyst is a Lewis Acid catalyst. The catalyst ensures a fast curing by decreasing the deblocking temperature and/or increasing the reaction rate between the polyol and isocyanate. A decrease in deblocking temperature has several benefits including faster production line speed utilization for continuous processes and/or lower yellowing tendencies. The fast cure response of a blocked isocyanate polyurethane coating product which is directly connected to the catalyst activity is therefore of utmost importance in such processes.

The need for a fast curing response often presents an additional challenge where there exists a need to provide a defined gloss target in the final coatings. The traditional way of reducing a coating's gloss, generally referred to as matting, is to use a solid matting agent. Silica based matting agents are generally known to be the most efficient matting agents in reducing the gloss of coatings in general and in polyurethane coatings in particular. However, an increase in silica matting agent may cause undesired side effects in the coating material.

For example, in polyurethane coating systems, the increase of silica matting agent may cause deactivation of the catalyst. This is particularly problematic in processes that require stringent catalyst activity, such as polyurethane type coil coatings applications. The market trends towards lower gloss polyurethane coil coating systems necessitating higher loadings of matting agents. In this case, the increase of silica matting agent may deactivate the catalyst to such a degree that it either leads to an under-cured coating or requires significantly increased amounts of catalyst leading to a higher cost coating.

To minimize the need to increase silica matting agents and avoid catalyst deactivation, organic matting agents are often used in combination with the silica matting agents. While the organic matting agents help to maintain acceptable catalyst activity, they tend to be less efficient and more costly than traditional silica matting agents, thereby increasing the costs associated with the coating systems.

Accordingly, there exists a need for matting agents which are cost effective and provide an acceptable gloss level, while simultaneously providing a high cure response in coating compositions, in particularly, polyurethane coating compositions comprising a catalyst.

### SUMMARY OF THE INVENTION

The present technology provides a matting agent for a polyurethane coating composition. The matting agent comprises porous silica particles having a ratio of BET surface area to pore volume (SA:PV) of 160 m²/mL or less. In any embodiment, the matting agent comprises porous silica particles having a ratio of BET surface area to pore volume (SA:PV) of 150 m²/mL or less. In any embodiment, the SA:PV may be about 80 m²/mL to about 160 m²/mL, about 80 m²/mL to about 150 m²/mL, or about 80 m²/mL to about 140 m²/mL. In an embodiment, the matting agent provides a curing response in the polyurethane coating composition of at least 100, at least 200, at least 250, or at least 300 double rubs, as determined by an MEK Double Rubs Test.

In another aspect, the technology provides a polyurethane coating composition that includes the matting agent as disclosed and described herein. In any embodiment, the polyurethane coating composition may be a polyurethane coil coating composition comprising the matting agent disclosed and described herein. In any embodiment, the polyurethane coating composition provides an excellent curing response and good matting efficiency without requiring a deleterious increase in catalyst. In any embodiment, the technology may provide good matting efficiency without the need to incorporate organic matting agents thereby providing a more cost effective polyurethane coating composition having an excellent curing response.

The technology also provides a coated substrate comprising a cured polyurethane coating comprising the matting agent disclosed and described herein. In any embodiment, the coated substrate may comprise at least one surface coated with the polyurethane coating composition disclosed herein. In any embodiment, the substrate may be a metal substrate. In any embodiment, the substrate may be a metal coil.

In yet another aspect, the technology provides a process of preparing polyurethane coating compositions comprising the matting agent disclosed and described herein and having improved curing response. In any embodiment, the polyurethane coating composition may have an excellent curing response and high matting efficiency without requiring a deleterious increase in catalyst.

The technology provides a process of coating a substrate with a polyurethane coating composition comprising the matting agent disclosed and described herein. In any embodiment, the substrate may be a metal. In any embodiment, the metal substrate may be in the form of a coil or can.

### DETAILED DESCRIPTION

The definitions of certain terms as used in this specification are provided below. Unless defined otherwise, all technical and scientific terms used herein generally have the same meaning as commonly understood by one of ordinary skill in the art to which the present technology belongs.

The following terms are used throughout as defined below.

As used herein and in the appended claims, singular articles such as “a,” “an,” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“About” in reference to a number is generally taken to include numbers that fall within a range of 1%, 5%, or 10% in either direction (greater than or less than) of the number unless otherwise stated or otherwise evident from the context (except where such number would be less than 0% or exceed 100% of a possible value).

Methylethylketone (MEK) Double Rubs Test refers to a test based on standard EN 13523-11:2011 in which resistance to solvents (rubbing test) is determined. The MEK test may be conducted by preparing panels by applying 60 μm of a polyurethane coating composition adjusted to a gloss of 10±2 GU at 60° on hot-dip galvanized steel panel pre-treated with Gardobond® X 4744 (purchased ready-made from Chemetall Group). The coated panels may be cured in a laboratory hot air oven type (from MATHIS AG) until a peak metal temperature of 230° C. is reached (measured in-situ by an infrared radiation pyrometer). Typical duration may range from about 48 to about 50 seconds. MEK double rubs may be performed using the LINEARTESTER 249 (from Erichsen). The double rub count value is based on the rub through resistance (i.e., the count is stopped after the metal substrate is visible).

The surface area (“SA”) of the porous silica particles useful as matting agents in the technology is determined by nitrogen adsorption measurement on a Micromeritics ASAP 2420 instrument using the Brunauer Emmett Teller (“BET”) theory or may be measured by a comparable instrument. The SA value is obtained from the evaluation of the linear region of the adsorption isotherm according to the theory of Brunauer, Emmett and Teller (see also Brunauer, S., Emmett, P. H. and Teller, E.: “Adsorption of gases in multimolecular layers,” J. Amer. Chem. Soc., 60, 309 (1938) (herein incorporated by reference)) by the ASAP 2420 software V2.09.

The pore volume (“PV”) of the porous silica particles useful as matting agents in the technology is determined by adsorption measurements with an unreactive gas (e.g., N₂) on a Micromeritics ASAP 2420 instrument. As will be understood by one skilled in the art, the PV may be determined by using any other comparable instrument. With the ASAP 2420, the amount of adsorbed unreactive gas is determined volumetrically as a function of the equilibrium partial pressure p/p₀ at the temperature of 77 K on the activated sample. The activated sample is prepared by drying a 1 g sample in a weighing jar with an open lid open for about 2 hours at 200° C. in a convection drying oven. The weighing jar is then be closed and allowed to cool to ambient temperature in a desiccator. The dried sample is activated for about 2 hours under vacuum, using the degas unit of the ASAP 2420 instrument. The PV value is determined according to the theory of Barrett, Joyner and Halenda (BJH) (see also Barrett, E. P., Joyner, L. G., Halenda, P. P.: “The determination of pore volume and area distribution in porous substances,” J. Am. Chem. Soc. 73 (1951) 373-380 (herein incorporated by reference)) for the pore diameter range corresponding to the relative pressures up to p/po 0.995 by the ASAP 2420 software V2.09.

The particle sizes of the porous silica particles of the embodiment may be measured by different physical methods known in the art including, but not limited to, a laser light scattering method(s). The median particle sizes of the porous silica particles disclosed and described herein were measured using a Malvern Mastersizer 2000 static laser light scattering instrument. As would be understood by one skilled in the art, other static laser light scattering instruments may be used as well.

The “median particle size” or “median particle size of the volume distribution” (also referred to as “D (v, 0.5)” or “D50”) refers to the particle size in microns at which 50% of the sample is smaller and 50% is larger, than that median particle size. For example, a sample preparation includes adding about 1 g of sample and 100 to 120 mL of deionized water to a 150 ml beaker. The tip of an ultrasonic resonator (Branson Sonifier W250D) is immersed 2 cm into the fluid and in the center of the beaker. Sonification can be conducted with a power setting of 55% for 10 s. Then a sufficient amount of the resulting slurry is immediately transferred into a testing cell of the Mastersizer instrument, following the requirements for concentration/obscuration of the user manual. The result from the analysis is the relative distribution of volume of particles in a range of size classes. Using the results, the size distribution is calculated and interpolated from a fit curve of the size values in order to obtain the median particle size.

As discussed above, while silica matting agents are used for reducing gloss in polyurethane coatings, silica matting agents may cause deactivation of the catalyst necessary to cure the coating. This results in either an under-cured coating with unacceptable performance or require higher amounts of catalyst. It has now been unexpectedly discovered that silica matting agents possessing specified SA to PV ratio, i.e., a SA:PV of 160 m²/mL or less, does not cause the catalyst to deactivate and results in a fast curing response.

It has been suggested that the mechanism of a catalyzed urethane curing works through an activation of the polyol alcohol by coordinating with the catalyst. (Houghton et al (Journal of Organometallic Chemistry 518, 1996, 21-27)). Not wishing to be bound by theory, it is speculated that the catalyst may instead coordinate with the —OH on a silica matting agent surface thus rendering the catalyst unavailable for the curing reaction. To maximize curing response, therefore, it may be necessary to minimize the number of —OH groups available from the silica matting agent. Thus, total number of —OH groups from the silica matting agent should be directly proportional to the SA of the silica matting agent and inversely proportional to the PV of silica matting agent used in a coating to achieve a certain gloss.

Accordingly, the present technology provides a matting agent for a polyurethane coating composition that comprises porous silica particles having a ratio of SA to PV (SA:PV) of 160 m²/mL or less. The technology also provides a polyurethane coating composition that includes the matting agent disclosed and described herein as well as a coated substrate comprising a cured coating of the polyurethane coating composition.

In any embodiment, the porous silica particles used as the matting agents in the present technology may have a SA:PV about 155 m²/mL or less. In any embodiment, the porous silica particles may have a SA:PV about 150 m²/mL or less. In any embodiment, the porous silica particles may have a SA:PV about 145 m²/mL or less. In any embodiment, the SA:PV may be about 140 m²/mL or less, about 135 m²/mL or less, or about 130 m²/mL or less. In any embodiment, the SA:PV may be at least about 80 m²/mL. In any embodiment, the SA:PV may be at least about 85 m²/mL, at least about 90 m²/mL, at least about 95 m²/mL, or at least about 100 m²/mL. In any embodiment, the SA:PV may be about 80 m²/mL to about 160 m²/mL. In any embodiment, the SA:PV may be about 80 m²/mL to about 150 m²/mL. In any embodiment, the SA:PV may be about 80 m²/mL to about 140 m²/mL. In any embodiment, the SA:PV may be about 85 m²/mL to about 155 m²/mL, about 90 m²/mL to about 145 m²/mL, about 95 m²/mL to about 135 m²/mL, or about 100 m²/mL to about 130 m²/mL.

In any embodiment, the porous silica particles used as the matting agents in the present technology may have a PV of at least about 0.4 mL/g), as determined by nitrogen porosimetry. In any embodiment, the PV may be at least about 0.6 mL/g or at least about 0.8 mL/g. In any embodiment, the PV may be about 3.5 mL/g of less. In any embodiment, the PV may be about 3.1 mL/g of less. In any embodiment, the PV may be about 2.5 mL/g or less, about 2.3 mL/g or less, or about 2.1 mL/g or less. In any embodiment, the porous silica particles may have a PV of about 0.4 mL/g to about 3.5 mL/g. In any embodiment, the porous silica particles may have a PV of about 0.6 mL/g to about 3.1 mL/g, about 0.8 mL/g to about 3.1 mL/g, about 0.8 mL/g to about 2.5 mL/g, about 0.8 mL/g to about 2.3 mL/g, or about 0.8 mL/g to about 2.1 mL/g.

In any embodiment, the porous silica particles used as the matting agents in the present technology may have a SA of about 525 m²/g or less, as determined by nitrogen porosimetry. In any embodiment, the SA may be about 465 m²/g or less, about 450 m²/g or less, about 425 m²/g or less, about 400 m²/g or less, about 375 m²/g or less, about 350 m²/g or less, or 320 m²/g or less. In any embodiment, the porous silica particles may have a SA of at least about 60 m²/g, as determined by nitrogen porosimetry. In any embodiment, the SA may be at least about 80 m²/g, at least about 100 m²/g, at least about 110 m²/g, or at least about 120 m²/g. In any embodiment, the SA may be about 60 m²/g to about 525 m²/g, about 80 m²/g to about 465 m²/g, about 90 m²/g to about 450 m²/g, about 100 m²/g to about 400 m²/g, about 110 m²/g to about 350 m²/g, or about 120 m²/g to about 320 m²/g.

In any embodiment, the porous silica particles useful as the matting agent may have a median particle size of about 1 μm to about 30 μm, as determined by laser light diffraction. In any embodiment, the porous silica particles may have a median particle size of about 3 μm to about 15 μm or about 5 μm to about 15 μm. In any embodiment, the porous silica particles may comprises at least one surface hydroxyl group. In any embodiment, the matting agent comprises a plurality of surface hydroxyl groups. In any embodiment, the porous silica particles may include silica gel, precipitated silica, pyrogenic silica particles, or a combination of two or more thereof. In any embodiment, the porous silica particles may include silica gel. In any embodiment, the porous silica particles may include precipitated silica. In any embodiment, the porous silica particles may include pyrogenic silica particles.

The production of the different silica types discussed herein have been described to a broad extent in the literature and are well known by those skilled in the art, for example in the Handbook of Porous Solids, 2008, Volume 3, edited by Ferdi Schueth, Kenneth S. W. Sing and Jens Weitkamp, p. 1543-1591, John Wiley & Sons (herein incorporated by reference).

Precipitated silicas in general are made using a wet process by the acidification of sodium silicate or other alkaline or alkaline earth metal under such conditions that primary particles formed are coagulated into clusters. Reaction conditions are utilized such that the entire liquid phase is not enclosed by the solid phase. For that reaction sulfuric acid is usually used (see e.g. DE 1299617), but other acids, such as hydrochloric acid, have been used (see e.g. EP 170578), organohalosilanes (see R. K. Iler, The Colloid Chemistry of silica and silicas, Cornell University Press, New York, 1955, Chapter 5), carbon dioxide (see e.g. U.S. Pat. No. 4,260,454) or a combination of carbon dioxide with mineral acids. Nearly all the commercial routes, however, are based on the sulfuric acid route. Precipitation is carried out mainly under alkaline conditions. The choice of agitation, duration of precipitation, the addition rate of reactants, their temperature, concentration, and pH, may vary the properties of the silica. Under standard conditions, sodium silicate (or alkali metal silicate) solutions and the acid are fed simultaneously into a stirred vessel containing water. The primary silica particles grow to sizes larger than 4-5 nm and are coagulated into aggregates by sodium ions coming from the sodium silicate. In the course of the precipitation, three-dimensional networks are formed. The formation of a gel stage is avoided by stirring at elevated temperatures. In the next stage the precipitated silica slurry is washed to remove soluble salts. The washing conditions, although important, have less effect on the final product properties than for silica gels. Different filter types may be used such as filter presses, rotary or belt filters. The resulting filter cake is subsequently dried and has a solid content between e.g. 15-25%. The most common drying techniques are fast drying procedures like spray drying, and slow drying procedures like rotary drying, which give rise to different particle shapes, degrees of agglomeration and, to a lesser extent, porosity (see e.g. DE 3639845). The dried silica may be subjected to milling and classifying steps to obtain a specific particle-size distribution. If required, an additional step may be included to further modify the silica, e.g. introduce a certain hydrophobicity and/or introduce other functionalities.

Silica gel, a porous solid amorphous form of hydrous silicon dioxide, has the nominal chemical formula of Si0₂·xH₂0. It is constituted by randomly linked spheroidal polymerized silicate particles, the primary particles. The properties of the silica gels are a result of the state of aggregation of the primary particles and the chemistry of their surfaces. The SA, porosity and surface chemistry may be controlled during the production process. Silica gel may be manufactured according to the Graham wet process that consists of releasing silicic acid from concentrated solutions of sodium silicate by a strong mineral acid like hydrochloric acid or sulfuric acid (see e.g. U.S. Pat. No. 1,297,724). The control of the pore structure is of great practical interest. The variation of the process conditions such as pH, electrolyte content, pore solvent, and the temperature during the different stages of the gel synthesis has a large impact on the pore structure of the final gel. Depending on the raw materials used for the gel synthesis, the hydrogel contains certain amounts of electrolytes, acid or base. These components may be removed in a washing step. Besides the washing conditions, the conditions during the subsequent aging such as pH, temperature, aging time, number of aging steps and solvent type are key to the pore-structure evolution. The drying process leads to the formation of a xerogel. The drying conditions have a high impact on the structure of the final gel. In a first phase, the gel shrinks to accommodate the liquid lost by evaporation. The greatest change in volume, weight, density and pore structure occur during this phase. The drying rate also affects the gel-network shrinkage. In a second phase, the pores are emptied. Fast drying results in less shrinkage than slow drying (C. J. Brinker, Transactions ACA, 1991, 27, 163).

Pyrogenic silica also referred to as or fumed silica or thermal silica, may be produced by a process for the production of extremely fine sized oxides by a high-temperature hydrolysis process (see DE 762723). The raw materials in this process are chloro-silanes, which are hydrolyzed in an oxygen-hydrogen flame. The silica is formed in an aerosol and is subsequently separated from the gaseous phase. Residual hydrogen chloride still adsorbed on the silica surface may be removed by using steam or air. The properties of the pyrogenic or fumed or thermal silica may be controlled by changing the reaction parameters, such as flame composition and temperature. This process generates silica with a primary particle size from 7 to 40 nm and a SA from 50 to 600 m²/g. The primary particles form aggregates by intergrowth and agglomerate through cohesion forces. An alternative thermal process to flame hydrolysis is the electric arc process, where quartz sand is reduced with coal to give silicon monoxide in the gas phase, which is subsequently oxidized into amorphous silica.

In any embodiment, the matting agent includes porous precipitated silica, which may be prepared by any conventional precipitation process to provide the final porous silica particles having the disclosed SA:PV ratio. In any embodiment, the matting agent may be produced by forming precipitated inorganic silica particles within a reaction mixture; separating the precipitated inorganic silica particles from liquid within the reaction mixture; washing the precipitated inorganic silica particles to produce washed precipitated inorganic silica particles; and rapidly drying the washed precipitated inorganic silica particles to form dried porous inorganic silica particles. In any embodiment, the dried porous inorganic silica particles may be milled to the desired mean particle size. In any embodiment, the rapid drying may be at a temperature of about 300° C. to about 350° C. for about 15 seconds or less (e.g., using a spin-flash drier). In a preferred embodiment, the precipitated silica useful in this technology may be produced by the method as disclosed and described in U.S. Pat. No. 4,590,052 B1 (herein incorporated by reference).

In any embodiment, the polyurethane coating composition includes the matting agent disclosed herein. In any embodiment, the polyurethane coating composition may additionally include a polyol, a cross-linking agent, and a catalyst.

In any embodiment, the polyol may include any known polyol used for preparing a polyurethane coating. Non-limiting polyols include polyacrylate polyols, polyester polyols, polyether polyols, polyurethane polyols, polyurea polyols, polyetherols, polycarbonates, polyester-polyacrylate polyols, polyester-polyurethane polyols, polyurethane-polyacrylate polyols, polyurethane-modified alkyd resins, fatty acid-modified polyester-polyurethane polyols, copolymers with allyl ethers, and copolymers and graft polymers thereof. In any embodiment, the polyol may include polyols for a polyurethane coating as disclosed in US 2005/0288450 (incorporated herein by reference).

In any embodiment, the cross-linking agent may be an isocyanate, preferably a polyisocyanate. The polyisocyanate may be any known polyisocyanate useful for preparation of a polyurethane coating including di- and/or triisocyanate. Examples of isocyanate monomers are (isomers not specified): Hexamethylene diisocyanate (HDI), Isophorone diisocyanate (IPDI), Toluene diisocyanate (TDI), Methylene diphenyl diisocyanate (MDI), Hydrogenated Methylene diphenyl diisocyanate (H₁₂MDI), xylylene diisocyanate (XDI), hydrogenated xylylene diisocyanate (H₆XDI), Trimethyl-1,6-diisocyanatohexane, Tetramethylxylylene diisocyanate (TMXDI), Triisocyanatononane (TIN), Triphenylmethane-4,4,4-triisocyanate, Tris(p-isocyanatophenyl)thiophosphate. Nonlimiting polyisocyanates contain two or more isocyanate groups and may be derived from aromatic, aliphatic, cycloaliphatic, and/or other monomeric groups that may be functionalized with isocyanate groups. In any embodiment, the cross-linking may include polyols for a polyurethane coating as disclosed in US 2005/0288450 (incorporated herein by reference).

In any embodiment, the cross-linking agent may be a polyisocyanate that is at least partly blocked. Non-limiting examples include polyisocyanates having isocyanate groups blocked with a thermally dissociable blocking agent such as an oxime compound, an acid amide compound, an amine compound, an active methylene compound, and/or a pyrazole compound. Another non-limiting example may be a blocked polyisocyanate obtained from reactions of components comprising a) at least one polyisocyanate selected from aromatic polyisocyanate, aliphatic polyisocyanate, cycloaliphatic polyisocyanate, and/or polyisocyanate-functional polymer; and b) at least one beta-diketone. Exemplary blocked polyisocyanates may include hexamethylene diisocyanate (HDI) type aliphatic polyisocyanate blocked with methylethyl ketone oxime (MEKO) such as Desmodur® BL 3175 (available from Covestro).

Overview of exemplary blocked polyisocyanate hardener products:

| Isocyanate type | Blocking agent |
|---|---|
| Hexamethylene diisocyanate (HDI) | Diethyl malonate (DEM) |
| Hexamethylene diisocyanate (HDI) | 3,5-Dimethyl-1H-pyrazole (DMP) |
| Hexamethylene diisocyanate (HDI) | Methylethyl ketone oxime (MEKO) |
| Hexamethylene diisocyanate (HDI) | ε-Caprolactone |
| Isophorone diisocyanate (IPDI) | 3,5-Dimethyl-1H-pyrazole (DMP) |
| Isophorone diisocyanate (IPDI) | Methylethyl ketone oxime (MEKO) |
| Isophorone diisocyanate (IPDI) | ε-Caprolactone |
| Isophorone diisocyanate (IPDI) | Acetone oxime |
| Hydrogenated Methylene diphenyl | Methylethyl ketone oxime (MEKO) |
| diisocyanate (H₁₂MDI) | |
| Toluene diisocyanate | ε-Caprolactone |
| Toluene diisocyanate | Methylethyl ketone oxime (MEKO) |

In any embodiment, the catalyst may include a Lewis acid catalyst. In any embodiment, the Lewis acid catalyst may include a tin catalyst, bismuth catalyst, zinc catalyst, or a combination of two or more thereof. Non-limiting examples of the tin catalyst includes dibutyltin dilaurate (DBTL), dioctyltin dilaurate (DOTL), dioctyltin dithioglycolate, dioctyltin diacetate (DOTA), dibutyltin diacetate (DBTA), dioctyltin dinonanoate, dioctyltin dicarboxylate, dioctyltin carboxylate, or a combination of two or more thereof. Non-limiting examples of the bismuth catalyst includes bismuth dicarboxylate. Non-limiting examples of the zinc catalyst includes zinc neodecanoate.

In any embodiment, the polyurethane coating composition disclosed and described herein may be produced by any known method for making polyurethane based coating compositions. In any embodiment, the polyurethane coating composition may be produced by combining and mixing the matting agent and a composition that includes the polyol, cross-linking agent, and catalyst disclosed and described herein using conventional means to form a polyurethane based coating composition. In any embodiment, the polyurethane coating composition may be produced by any method as disclosed in US 2005/0288450 (incorporated herein by reference).

In any embodiment, the polyurethane coating composition may include about 10 wt % to about 75 wt % (including about 15 wt % to about 60 wt % or about 20 wt % to about 50 wt %) of the polyol. In any embodiment, the polyurethane coating composition may include about 0.001 wt % to about 5 wt % (including about 0.01 wt % to about 3 wt % or about 0.1 wt % to about 1 wt %) of the catalyst. In any embodiment, the polyurethane coating composition may include about 1 wt % to about 25 wt % (including about 3 wt % to about 20 wt % or about 5 wt % to about 15 wt %) of the cross-linking agent.

In any embodiment, the polyurethane coating composition can include the matting agent in any amount sufficient to provide the cured coating which exhibits a 60° gloss of about 80 or less. For example, the polyurethane coating composition can include about 0.1 wt % to about 15 wt % (including about 1 wt % to about 10 wt %) of the matting agent. In any embodiment, the polyurethane coating composition can include about 0 wt % to about 50 wt % (including about 5 wt % to about 40 wt % or about 10 wt % to about 30 wt %) of a pigment (e.g., titanium dioxide). In any embodiment, the polyurethane coating composition can include about 0.1 wt % to about 60 wt % (including about 5 wt % to about 50 wt % or about 10 wt % to about 40 wt %) of a solvent.

In any embodiment, the polyurethane coating composition may include any other known component conventionally included in a polyurethane coating composition, nonlimiting examples include solvents, diluents, extenders, pigments, dyes, and/or additives. In any embodiment, the polyurethane coating composition may include any additional component as disclosed in US 2005/0288450 (incorporated herein by reference). In any embodiment, the polyurethane coating composition may include any component as disclosed in US 2005/0288450 at the amount disclosed therein (incorporated herein by reference).

The present technology also provides a method for preparing the coated substrate comprising applying a layer of the polyurethane coating composition disclosed and described herein to the substrate disclosed and described herein. In any embodiment, the method may further include curing the layer of the polyurethane coating composition to form a coating on at least on surface of the substrate. In any embodiment, the curing may include removing volatiles and/or crosslinking the polyol.

In any embodiment, the substrate coated by the polyurethane coating composition provided herein may be metal, for example iron and alloys of iron, steel and alloys of steel, copper and alloys of copper, tin and alloys of tin, aluminum and alloys of aluminum, zinc and alloys of zinc. The metals may be coated with another metallic layer, for example hot dip galvanized zinc. The metal may be treated artificially to create a certain pre-treatment and/or passivation layer. In any embodiment, the substrate may be a metal coil.

In any embodiment, the substrate may be treated using any conventional coating techniques (e.g., roll coating, doctor blading, spraying and the like) to form a layer or coating on the substrate. Thereafter, the polyurethane coating is cured under the conditions sufficient to remove any the volatile constituents and form a cured polyurethane coating on the substrate. In any embodiment, the thickness of the cured polyurethane coating may vary depending on the intended use. In any embodiment, the cured polyurethane coating for coil coating applications may have a thickness of about 1 μm to about 120 μm including about 10 μm to about 50 μm or about 15 μm to about 35.

In any embodiment, the cured polyurethane coating may have a 60° gloss of about 80 or less. In any embodiment, the cured polyurethane coating may have a 60° gloss of about 70 or less (including about 60 or less or about 50 or less).

In any embodiment, the matting agent enables a curing response in the polyurethane coating composition of at least 100 double rubs, as determined by an MEK Double Rubs Test. In any embodiment, the matting agent enables a curing response in the polyurethane coating composition of at least 200 double rubs. In any embodiment, the matting agent enables a curing response in the polyurethane coating composition of at least 250 double rubs or at least 300 double rubs. In any embodiment, the polyurethane coating composition comprising the matting agent provides a curing response of at least 100 double rubs, as determined by an MEK Double Rubs Test. In any embodiment, the polyurethane coating composition provides a curing response of at least 200 double rubs. In any embodiment, the polyurethane coating composition provides a curing response of at least 250 double rubs or at least 300 double rubs. In any embodiment, the coated substrate comprising a cured coating of the polyurethane coating composition exhibits a curing response of at least 100 double rubs, as determined by an MEK Double Rubs Test. In any embodiment, the coated substrate comprising a cured coating of the composition exhibits a curing response of least 200 double rubs. In any embodiment, the coated substrate exhibits a curing response of at least 250 double rubs or at least 300 double rubs.

In any embodiment, the curing response may be obtained without the need of an organic matting agent. Organic matting agents may be methylendiaminomethylether-polycondensate type (Deuteron MK), polyamide type (Orgasol range), polyurethane type, poly methyl methacrylate type, poly styrene type, HDPE wax type or a mixture thereof depending if curing temperature in the process is suitable for the respective organic matting agent.

The present technology also provides 1-pack and 2-pack coating kits. The 2-pack kits may include a first pack that includes the matting agent disclosed and described herein, the polyol, and the catalyst; and a second pack that includes the cross-linking agent. The 1-pack kits may include the matting agent disclosed and described herein, the polyol, the catalyst, and the cross-linking agent (e.g., the blocked cross-linking agent).

### EXAMPLES

The present technology is further illustrated by the following examples, which should not be construed as limiting in any way.

The surface area of the silica particles expressed in the examples and tables was determined by nitrogen adsorption measurement on a Micromeritics ASAP 2420 instrument using the BET theory. The pore volume expressed in the examples was determined by adsorption measurements with an unreactive gas (e.g., N₂) on a Micromeritics ASAP 2420 instrument as disclosed and described herein above. The MEK Double Rubs Test used to test samples in the examples was conduct based on standard EN 13523-11:2011 as disclosed and described herein above.

### Example 1: Polyurethane Coating Compositions Containing a Porous Silica Matting Agent

A polyurethane coating composition 1 (Ex. 1) was produced having the components provided in Table 1. The coating composition was produced by combining components 1-6 (Table 1) in a water cooled container and dispersed using a bead mill at 2500 RPM for 60 minutes. Next, components 7-10 (Table 1) were slowly added at 2000 RPM and dispersed for 10 minutes to provide the base coating composition. Finally, matting agent 1 (4.3 g) was added to the base coating composition (100 g) and dispersed using a high speed dissolver ((dissolver blade diameter: 40 mm; 3000 RPM) for 10 minutes to provide the polyurethane coating composition. The amount of the matting agent added was determined to provide a target gloss of 10±2 GU at 60° using a matting curve. The matting curve was determined by adding 3 g to 8 g of the matting agent to 100 g of the base coating composition and measuring the gloss after curing. The matting agent amount to achieve the target gloss was extrapolated from the resulting matting curve.

TABLE 1
Base Coating Composition

| No. | Component | Wt % |
|---|---|---|
| 1 | saturated, low molecular weight, branched polyester (DYNAPOL ® LH | 41.40 |
| | 538-02 / 65%) | |
| 2 | Paste of oxidized polyethylene modified with polyamide thixotrope | 0.30 |
| | (DISPARLON ® NS-30) | |
| 3 | Titanium dioxide pigment (rutile, chloride process) treated with | 29.20 |
| | aluminum, zirconium and silica compounds (KRONOS ® 2310) | |
| 4 | Solvent (dibasic ester) | 5.20 |
| 5 | Solvent (propylencarbonate) | 4.20 |
| 6 | C₉-C₁₀ aromatic hydrocarbon solvent (ShellSol ® A100) | 3.15 |
| 7 | HDI type aliphatic polyisocyanate blocked with methylethyl ketone oxime | 7.70 |
| | (MEKO) (Desmodur ® BL 3175 / 75%) | |
| 8 | Catalyst (Dibutyltin dilaurate (Dabco ® T-12)) | 0.30 |
| 9 | silicone-free acrylic polymer surface control agent in | 3.40 |
| | Solvent naphtha (petroleum), heavy arom. (DISPARLON ® 1980 / 10% in | |
| | ShellSol A200) | |
| 10 | C₉-C₁₀ aromatic hydrocarbon solvent (ShellSol ® A100) | 5.20 |
| | Total | 100.00 |

Following the same method and using the same components in Table 1, polyurethane coating compositions 2-10 were produced (Ex. 2-10) except matting agent 1 was substituted with matting agents 2-10, respectively (Table 2). For each composition, the amount of the respective matting agent was determined by a matting curve following the above procedure to achieve the target gloss of 10±2 GU at 60°.

TABLE 2
Matting Agents 1-10

| | | | | | | Matting |
|---|---|---|---|---|---|---|
| Example | | | | PV | | agent |
| coating | Matting | D50 | SA | (0.995ads) | SA/PV_{0.995} | dosage |
| composition | agent | [μm] | [m²/g] | [mL/g] | [m²/mL] | [wt %] |
| Ex. 1 | Matting | 9.7 | 186 | 1.7 | 109.4 | 4.1 |
| | agent 1 | | | | | |
| Ex. 2 | Matting | 7.0 | 190 | 1.58 | 120.3 | 4.6 |
| | agent 2 | | | | | |
| Ex. 3 | Matting | 9.8 | 212 | 1.67 | 126.9 | 4.5 |
| | agent 3 | | | | | |
| Ex. 4 | Matting | 11.0 | 170 | 1.22 | 139.3 | 4.5 |
| | agent 4 | | | | | |
| Ex. 5 | Matting | 11.0 | 170 | 1.22 | 139.3 | 4.9 |
| | agent 5 | | | | | |
| Ex. 6 | Matting | 10.4 | 179 | 1.19 | 150.4 | 4.5 |
| | agent 6 | | | | | |
| Ex. 7 | Matting | 10.0 | 197 | 1.31 | 150.4 | 4.5 |
| | agent 7 | | | | | |
| Ex. 8 | Matting | 10.4 | 199 | 1.18 | 168.6 | 4.4 |
| | agent 8 | | | | | |
| Ex. 9 | Matting | 8.7 | 398 | 1.78 | 223.6 | 3.8 |
| | agent 9 | | | | | |
| Ex. 10 | Matting | 8.7 | 645 | 2.02 | 319.3 | 3.4 |
| | agent 10 | | | | | |

The final coating compositions were each applied (60 μm wet film thickness) to a hot-dip galvanized steel panel pre-treated with Gardobond® X 4744 (purchased ready-made from Chemetall Group). The coated panel was cured in a laboratory hot air oven type (from MATHIS AG) until a peak metal temperature of 230° C. was reached (measured in-situ by an infrared radiation pyrometer) (duration was about 48 to 50 seconds). The MEK Double Rubs Test was then conducted using the LINEARTESTER 249 (from Erichsen) as described herein. The double rub count value was based on the rub through resistance (i.e., the count was stopped after the metal substrate was visible). The results of the MEK Double Rubs Test are provided in Table 3. The results demonstrate that matting agents with a ratio of SA:PV of 160 m²/mL or less were either “fair” or “good” and the coatings with a matting agent having a SA:PV of 140 m²/mL or less were all “good.”

TABLE 3
MEK Double Rubs Test Results

| | | 60° | | MEK |
|---|---|---|---|---|
| Example coating | | gloss | SA/PV_{0.995} | Double |
| composition | Matting agent | [GU] | [m²/mL] | Rubs |
| Ex. 1 | Matting agent 1 | 10 ± 2 | 109.4 | 500 |
| Ex. 2 | Matting agent 2 | 10 ± 2 | 120.3 | 500 |
| Ex. 3 | Matting agent 3 | 10 ± 2 | 126.9 | 500 |
| Ex. 4 | Matting agent 4 | 10 ± 2 | 139.3 | 500 |
| Ex. 5 | Matting agent 5 | 10 ± 2 | 139.3 | 438 |
| Ex. 6 | Matting agent 6 | 10 ± 2 | 150.4 | 500 |
| Ex. 7 | Matting agent 7 | 10 ± 2 | 150.4 | 213 |
| Ex. 8 | Matting agent 8 | 10 ± 2 | 168.6 | 63 |
| Ex. 9 | Matting agent 9 | 10 ± 2 | 223.6 | 11 |
| Ex. 10 | Matting agent 10 | 10 ± 2 | 319.3 | 5 |

Good MEK resistance is >400;
fair MEK resistance is 100-400; and
low MEK resistance is <100

### CERTAIN EMBODIMENTS

Embodiment 1. A matting agent for a polyurethane coating composition comprising porous silica particles having a ratio of BET surface area to pore volume (SA:PV) of 160 m²/mL or less.

Embodiment 2. The matting agent of Embodiment 1, wherein the matting agent enables a curing response in the polyurethane coating composition of at least 100 double rubs, as determined by an MEK Double Rubs Test.

Embodiment 3. The matting agent of Embodiment 1 or Embodiment 2, wherein the SA:PV is about 150 m²/mL or less.

Embodiment 4. The matting agent of Embodiment 3 wherein the SA:PV is about 140 m²/mL or less.

Embodiment 5. The matting agent of any one of Embodiments 1-4, wherein the SA:PV is at least about 80 m²/mL.

Embodiment 6. The matting agent of Embodiment 5, wherein the SA:PV is at least about 100 m²/mL.

Embodiment 7. The matting agent of any one of Embodiments 1-6, wherein the porous silica particles have a median particle size of about 1 μm to about 30 μm.

Embodiment 8. The matting agent of Embodiment 7, wherein the porous silica particles have median particle size of about 3 μm to about 15 μm.

Embodiment 9. The matting agent of any one of Embodiments 1-8, wherein the porous silica particles comprise silica gel, precipitated silica, pyrogenic silica particles, or a combination of two or more thereof.

Embodiment 10. The matting agent of any one of Embodiments 9, wherein the porous silica particles comprise precipitated silica.

Embodiment 11. The matting agent of any one of Embodiments 1-10, wherein the matting agent provides a curing response of at least 100 double rubs without the need of an organic matting agent.

Embodiment 12. A polyurethane coating composition comprising the matting agent of any one of Embodiments 1-11.

Embodiment 13. The coating composition of Embodiment 12 wherein the composition exhibits a curing response of at least 100 double rubs, as determined by an MEK Double Rubs Test.

Embodiment 14. The coating composition of Embodiment 13 wherein the composition exhibits a curing response of at least 200 double rubs, as determined by an MEK Double Rubs Test.

Embodiment 15. The coating composition of Embodiment 13 or Embodiment 14, wherein the curing response is obtained without the need of an organic matting agent.

Embodiment 16. The coating composition of any one of Embodiments 12-15 further comprising a polyol, a cross-linking agent, and a catalyst.

Embodiment 17. The coating composition of Embodiment 16, wherein the catalyst is a Lewis acid catalyst.

Embodiment 18. The coating composition of Embodiment 17, wherein the Lewis acid catalyst comprises a tin, bismuth, or zinc catalyst.

Embodiment 19. The coating composition of Embodiment 18, wherein the tin catalyst comprises dibutyltin dilaurate (DBTL), dioctyltin dilaurate (DOTL), dioctyltin dithioglycolate, dioctyltin diacetate (DOTA), dibutyltin diacetate (DBTA), dioctyltin dinonanoate, dioctyltin dicarboxylate, dioctyltin carboxylate, or a combination of two or more thereof.

Embodiment 20. The coating composition of Embodiment 18 or Embodiment 19, wherein the bismuth catalyst comprises bismuth dicarboxylate.

Embodiment 21. The coating composition of any one of Embodiments 18-20, wherein the zinc catalyst comprises zinc neodecanoate.

Embodiment 22. The coating composition of any one of Embodiments 16-21, wherein the cross-linking agent is an isocyanate.

Embodiment 23. The coating composition of Embodiment 22, wherein the isocyanate is a polyisocyanate.

Embodiment 24. The coating composition of Embodiment 22 or Embodiment 23, wherein the cross-linking agent is a blocked cross-linking agent.

Embodiment 25. A coated substrate comprising a cured coating of the coating composition of any one of Embodiments 12-24.

Embodiment 26. The coated substrate of Embodiment 25, wherein the substrate is metal.

Embodiment 27. The coated substrate of Embodiment 25 or Embodiment 26, wherein the substrate is a metal coil.

Embodiment 28. The coated substrate of any one of Embodiments 25-27, wherein the cured coating exhibits a curing response of at least 100 double rubs, as determined by an MEK Double Rubs Test.

Embodiment 29. The coated substrate of any one of Embodiments 25-28, wherein the cured coating has a thickness of about 1 μm to about 120 μm.

Embodiment 30. A method for preparing the polyurethane coating composition of any one of Embodiments 12-24, the method comprising combining and mixing the matting agent of any one of Embodiments 1-11 with a composition comprising a polyol, a cross-linking agent, and a catalyst to form the polyurethane coating composition.

Embodiment 31. The method of Embodiment 30 wherein the catalyst is a Lewis acid catalyst.

Embodiment 32. The method of Embodiment 30 or Embodiment 31, wherein the cross-linking agent is an isocyanate.

Embodiment 33. The method of Embodiment 32, wherein the isocyanate is a polyisocyanate.

Embodiment 34. The method of Embodiment 32 or Embodiment 33, wherein the cross-linking agent is a blocked cross-linking agent.

Embodiment 35. A method for preparing the coated substrate of any one of Embodiments 25-29, the method comprising applying a layer of the polyurethane coating composition of any one of Embodiments 12-24 to a substrate.

Embodiment 36. The method of Embodiment 35 further comprising curing the layer to remove volatiles and form a coating on at least on surface of the substrate.

Embodiment 37. The method of Embodiment 35 or Embodiment 36, wherein the substrate is metal.

Embodiment 38. The method of any one of Embodiments 35-37, wherein the substrate is a metal coil.

The present technology is not to be limited in terms of the particular embodiments described in this application, which are intended as single illustrations of individual aspects of the present technology. Many modifications and variations of this present technology may be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions, or biological systems, which may, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third, and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member. Thus, for example, a group having 1-3 atoms refers to groups having 1, 2, or 3 atoms. Similarly, a group having 1-5 atoms refers to groups having 1, 2, 3, 4, or 5 atoms, and so forth.

All patents, patent applications, provisional applications, and publications referred to or cited herein are incorporated by reference in their entirety, including all figures and tables, to the extent they are not inconsistent with the explicit teachings of this specification.

1.-38. (canceled)

39. A polyurethane coating composition comprising a matting agent, the matting agent comprising porous silica particles having a ratio of BET surface area to pore volume (SA:PV) of 160 m²/mL or less.

40. The polyurethane coating composition of claim 39, wherein the matting agent enables a curing response in the polyurethane coating composition of at least 100 double rubs, as determined by an MEK Double Rubs Test, optionally wherein the curing response is obtained without the need of an organic matting agent.

41. The polyurethane coating composition of claim 39, wherein the SA:PV is at least about 80 m²/mL.

42. The polyurethane coating composition of claim 39, wherein the porous silica particles have a median particle size of about 1 μm to about 30 μm.

43. The polyurethane coating composition of claim 39, wherein the porous silica particles comprise silica gel, precipitated silica, pyrogenic silica particles, or a combination of two or more thereof.

44. The polyurethane coating composition of claim 39 further comprising a polyol, a cross-linking agent, and a catalyst.

45. The polyurethane coating composition of claim 44, wherein the catalyst is a Lewis acid catalyst,

46. The polyurethane coating composition of claim 45, wherein the Lewis acid catalyst comprises a tin, bismuth, or zinc catalyst.

47. The polyurethane coating composition of claim 46, wherein the tin catalyst comprises dibutyltin dilaurate (DBTL), dioctyltin dilaurate (DOTL), dioctyltin dithioglycolate, dioctyltin diacetate (DOTA), dibutyltin diacetate (DBTA), dioctyltin dinonanoate, dioctyltin dicarboxylate, dioctyltin carboxylate, or a combination of two or more thereof.

48. The polyurethane coating composition of claim 46, wherein the bismuth catalyst comprises bismuth dicarboxylate.

49. The polyurethane coating composition of claim 46, wherein the zinc catalyst comprises zinc neodecanoate.

50. The polyurethane coating composition of claim 44, wherein the cross-linking agent is an isocyanate, optionally wherein the cross-linking agent is a blocked cross-linking agent.

51. A coated substrate comprising a cured coating of the polyurethane coating composition of claim 39.

52. The coated substrate of claim 51, wherein the substrate is metal.

53. A method for preparing the polyurethane coating composition of claim 39, the method comprising combining and mixing a matting agent with a composition comprising a polyol, a cross-linking agent, and a catalyst to form the polyurethane coating composition, wherein the matting agent comprises porous silica particles having a ratio of BET surface area to pore volume (SA:PV) of 160 m²/mL or less.

54. The method of claim 53, wherein the catalyst is a Lewis acid catalyst, and the cross-linking agent is an isocyanate, optionally wherein the cross-linking agent is a blocked cross-linking agent.

55. A method for preparing the coated substrate of claim 51, the method comprising applying a layer of the polyurethane coating composition of claim 39 to a substrate.

56. The method of claim 55 further comprising curing the layer to remove volatiles and form a coating on at least on surface of the substrate.

57. A matting agent for a polyurethane coating composition comprising porous silica particles having a ratio of BET surface area to pore volume (SA:PV) of 160 m²/mL or less.

58. The matting agent of claim 57, wherein the matting agent enables a curing response in the polyurethane coating composition of at least 100 double rubs, as determined by an MEK Double Rubs Test.
